(19) United States
(12) Patent Application Publication
(10) Pub. No.: US 2003/0123082 A1
(43) Pub. Date: Jul. 3, 2003

(54) System and method for transferring print software from a printing device to a computing device

(76) Inventors: David M. Hall, Camas, WA (US); Stephen D. Dentel, Vancouver, WA (US); Jeff M. Anderson, Camas, WA (US); Marc C. Biundo, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/040,506

(22) Filed: Dec. 27, 2001

(51) Int. Cl. B41J 1/00; G06F 15/00

(52) U.S. Cl. 358/1.15

(57) ABSTRACT

A system and method for use in enabling a computing device to print a document on a printing device. The system typically includes a printing device configured to establish a communication link with a computing device. The printing device typically includes memory having print software stored therein. The print software is typically transferable to and executable on the computing device and, upon execution, is typically configured to enable the computing device to print documents to the printing device. The printing device is typically configured to download the print software to the computing device upon establishment of the communication link between the printing and computing devices. The method typically includes detecting the establishment of a communication link between a computing device and a printing device. The method further includes, in response to the establishment of the communication link, downloading print software stored in the memory of the printing device to the computing device, the print software being useful for the computing device to print documents on the printing device.

### BACKGROUND OF THE INVENTION

Portable computers are often used in a variety of locations by their users. For example, a single user may use a portable computer at home, at work, or while traveling. At home, the user may work in a kitchen, home-office, den, or bedroom, for example. At work, the user may use the portable computer in a number of offices and meeting rooms, which are often located in separate buildings of a corporate complex. While traveling, the user may use the device at an airport lounge, hotel room, conference center, or meeting room.

In each of these different locations, the user may desire to print a document to a local printer from the portable computer. Printer systems generally require the user to configure the portable computer to print to each local printer in each location, typically by locating and installing a compatible print driver for each printer on the portable computer.

One problem with these systems is that the proper print driver may be difficult to locate and install. The installation process of the driver is often complex, and sometimes cannot be completed without specialized guidance or assistance.

As a result, users often copy files onto a diskette or writable CD ROM, and open and print the files from another local computer that is already configured to print to the printer. However, diskettes can only hold a small amount of data, and CD ROM Writers may not be available in all instances.

Even if the user succeeds in copying the files to a diskette or CD ROM, the user may face another problem, namely, that the user may not be able to open and print the file from the local computer because it lacks suitable software to read the file. For example, an architect desiring to print CAD drawings stored on the architect's laptop computer during a visit to a client's office may discover that it is impossible to open the files on the client's local computer, because, unlike the architect's laptop, the client's computer does not have specialized CAD software necessary to open the drawings.

### SUMMARY OF THE INVENTION

A system and method for use in enabling a computing device to print a document on a printing device is provided. The system typically includes a printing device configured to establish a communication link with a computing device. The printing device typically includes memory having print software stored therein. The print software is typically transferable to, and executable on, the computing device and, upon execution, is typically configured to enable the computing device to print documents to the printing device. The printing device is typically configured to download the print software to the computing device upon establishment of the communication link between the printing and computing devices.

The method typically includes detecting the establishment of a communication link between a computing device and a printing device. The method further includes, in response to the establishment of the communication link, downloading print software stored in the memory of the printing device to the computing device, the print software being useful for the computing device to print documents on the printing device.

### BRIEF DESCRIPTION OF THE FIGURES

FIG. 1 is a schematic view of a system configured to enable a computing device to print a document using a wireless communication link in accordance with one embodiment of the present invention.

FIG. 2 is a schematic view of a system configured to enable a computing device to print a document using a hardware communication link in accordance with another embodiment of the present invention.

FIG. 3 is a flowchart of a method for use in printing a document from a computing device on a printing device according to one embodiment of the present invention.

FIG. 4 is a flowchart of a method for use in printing a document from a computing device on a printing device using a hardware communication link, according to another embodiment of the present invention.

FIG. 5 is a flowchart of a method for use in printing a document from a computing device on a printing device using a wireless communication link, according to another embodiment of the present invention.

### DETAILED DESCRIPTION OF THE INVENTION

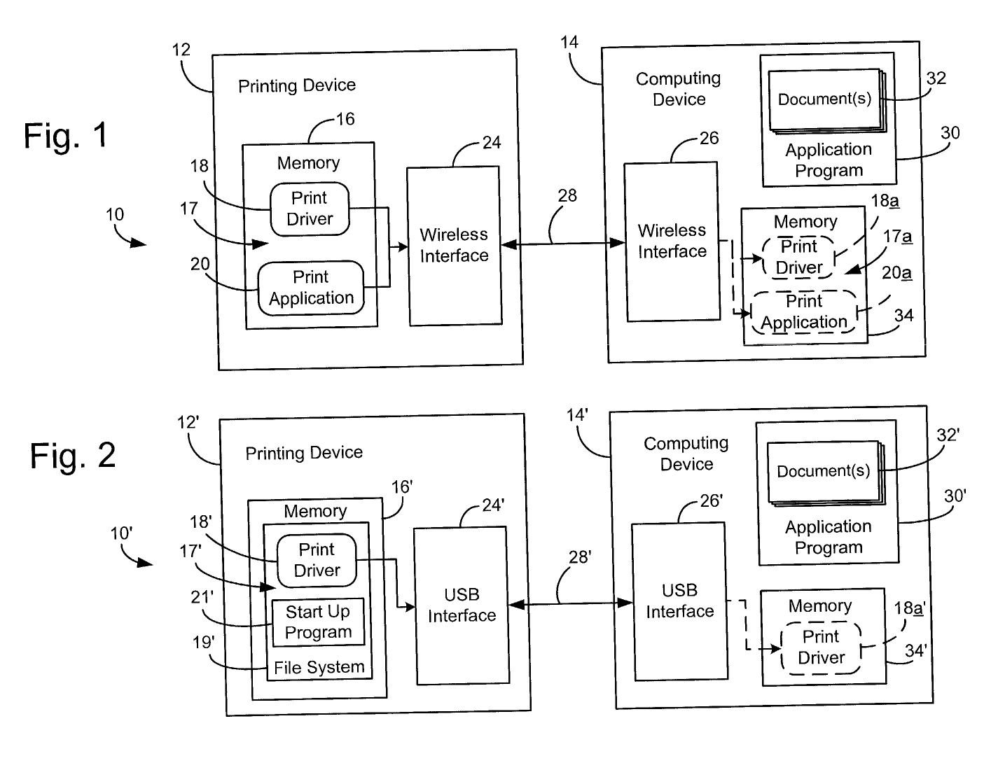

Referring initially to FIG. 1, a system for use in enabling a computing device to print a document is generally shown at 10. System 10 typically includes a printing device 12 configured to communicate with a computing device 14, and to transfer to computing device 14 print software, discussed below, which is necessary for computing device 14 to print documents on printing device 12.

Typically, printing device 12 is a printer, fax machine, copier, or other device capable of printing documents, either portable or stationary. Computing device 14 is typically a laptop computer, personal-data-assistant (PDA) or virtually any other type of computing device capable communicating with printing device 12, again, either portable or stationary. Computing device 14 typically is configured to execute an application program 30, such as a word processing program, and to store one or more documents 32 for printing. Documents 32 may be word processing documents, spreadsheet documents, computer aided drafting (CAD) documents, or virtually any other type of printable documents that can be transferred from computing device 14 to printing device 12.

Printing device 12 typically includes memory 16 and a communications interface 24. Typically, communications interface 24 is a wireless communications interface, although other suitable communications interfaces may also be used. Memory 16 is typically a non-volatile device for storing computer programs and data, and may be random-access memory (RAM), read-only memory (ROM), Flash memory, a hard drive, CD ROM drive, or other suitable memory device capable of storing software thereon. Printing device 12 also typically includes print software 17 stored in memory 16. Print software 17 is typically configured to be transferable to, installable on, and executable on, computing device 14. Further, upon execution of print software 17 on computing device 14, the software 17 is configured to enable computing device 14 to print documents on printing device 12.

Typically, print software 17 includes at least one print driver 18 and/or print application 20. In addition, the print software may include other print utilities, programs or data necessary for, or utilized by, computing device 14 in printing a document on printing device 12. According to one embodiment of the present invention, the print software may include a plurality of print drivers and/or a plurality of print applications, and the printing device may be configured to identify and select a compatible and/or optimum print driver and/or print application from among the many drivers and applications, as discussed in detail below.

Print driver 18 is typically software downloadable to, and executable on, computing device 14, which acts as a translator between an application program 30 executed on computing device 14 and the printing device 12, and enables application program 30 to print documents 32 on the printing device. Print application 20 is typically software downloadable to, and executable on, computing device 14, which, upon execution, is configured to send print jobs from computing device 14 to print device 12. According to one embodiment of the invention, print application 20 is an application configured to enable driver 18 to print across a wireless communication link such as an infrared or radio frequency communication link.

Wireless interface 24 is configured to communicate with a corresponding wireless interface 26 included on computing device 14. Printing device 12 and computing device 14 are configured to establish a communication link 28 via the wireless interfaces 24, 26. Printing device 12 is typically configured to download print software 17 to computing device 14 in response to the establishment of the communication link 28 between printing device 12 and computer device 14. The print software may be downloaded automatically as soon as the communication link is established, or alternatively, at some pre-established time thereafter, or upon a user request.

Printing device 12 is typically configured to identify and to select print software that is compatible with computing device 14. This may be accomplished by computing device 14 sending certain compatibility information over communication link 28. For example, the computing device 14 may send a product identifier, operating system identifier, etc., to the printing device. Based on this information the printing device 12 may be configured to select optimal print software for use on computing device 14 from among a plurality of software components stored in memory. Such selection may be based on predefined optimization criteria such as software version, creation date, etc. After the printing device has identified and selected the print software for download, the printing device is configured to download the print software to the computing device via the communication link.

According to one embodiment of the invention, communication link 28 is established in response to a query from computing device 14 to printing device 12. According to another embodiment of the invention, printing device 12 is configured to periodically broadcast a signal to computing device 14 for the purpose of establishing communication link 28.

In response to the communication link being established, the computing device is typically configured to download the print software 17 necessary for printing a document 32 (on printing device 12) from printing device 12. The computing device is typically configured to store the print software in memory 34, as shown at 17a, 18a, 20a, and execute the print software in order to print the document 32 on the printing device. While the print software is shown and described as being stored in memory on printing device 12 (and computing device 14), it will be appreciated that the print software 17 may be stored at some other location accessible by the computing device or printing device.

Once the print software 17 is downloaded and installed, the user may print document 32 from computing device 14 on printing device 12. Typically, the print driver 18 is configured to translate the document into a print job, and the print application 20 is configured to transfer the print job across the wireless communication link 28 to printing device 12. The printing device is configured to receive and execute the print job.

FIG. 2 shows a system 10′ for use in enabling a computing device to print a document on a printing device according to another embodiment of the present invention. The components of system 10′ are similar to system 10 described above, and are numbered correspondingly, and thus will not be redescribed in detail, except for the differences explained below.

Printing device 12′ includes memory 16′ configured to store print software 17′ such as print driver 18′, within a file system 19′. As used herein the term “file system” refers to a system, recognizable by the operating system of computing device 14′, which is used to keep track of files stored on the printing device. The file system typically includes a hierarchical directory of folders, each of which may include one or more data files. The file system may also include a root directory.

The file system is typically recognizable by the computing device 14′ upon establishment of a communication link 28′ over a printing device universal serial bus (USB) interface 24′ and a corresponding computing device USB interface 26′. Because communication link 28′ is established using USB hardware, it is referred to herein generally as a hardware communication link, and more particularly as a USB communication link. Alternatively, it will be understood that another suitable hardware communication link, or a wireless communication link, as described above, may be used. Computing device 14′ may take the form of a stationary computing device such as a desktop computer, or a portable computing device such as a laptop. Alternatively, a PDA or virtually any other computing device capable of establishing a hardware link with printing device 12′ may be used.

Printing device 12′ is typically configured to download print software 17′ to computing device 14′ in response to the establishment of hardware communication link 28′. Typically, the file system includes a start-up program 21′ configured to be downloaded to and executed by the computing device upon recognition of the file system by computing device 14′. Start-up program 21′ also may be configured to download the other portions of print software to the computing device. Typically, the start-up program is recognized and automatically executed by the operating system of the computing device.

Typically, computing device 14′ of system 10′ is configured to download only print driver 18′ for storage on memory 34′, at 18a′. Alternatively, the computing device 14′ may also be configured to download other print software necessary for application program 30′ to print a document 32′ on printing device 12′.

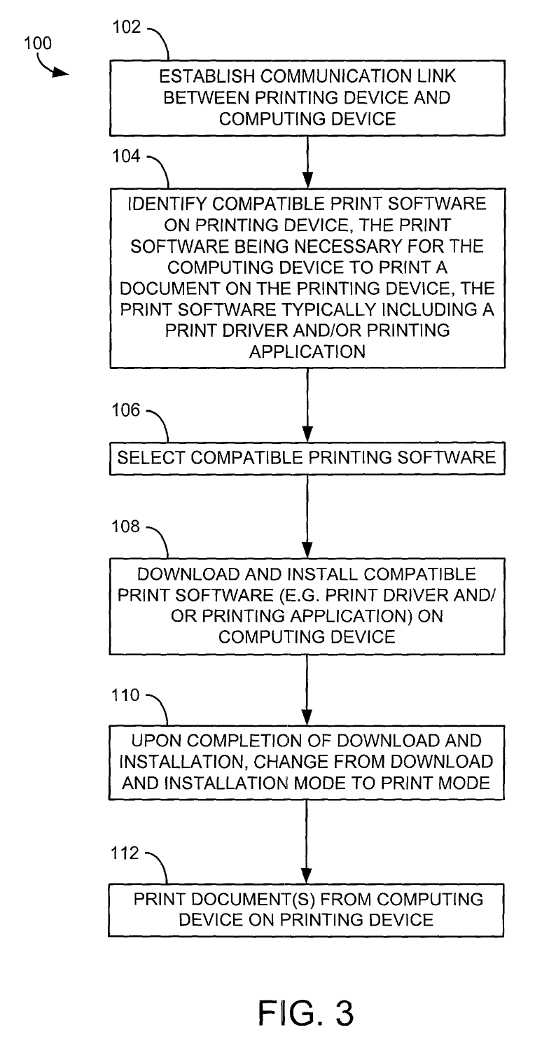

FIG. 3 shows a method 100 for use in printing a document from a computing device on a printing device. Typically the method embodiments described herein are implemented using the above-described systems 10, 10′, although it will be understood that various other suitable computer hardware components may be used.

Method 100 typically includes, at 102, establishing a communication link 28, 28′ between a printing device 12, 12′ and a computing device 14, 14′. At 104, the method typically includes identifying compatible print software 17, 17′ on the printing device 12, 12′. As described above, the print software 17, 17′ is software necessary for the computing device 14, 14′ to print a document 32, 32′ on the printing device 12, 12′. The print software may include a print driver 18, 18′ and/or a print application 20. Typically, the printing device stores a plurality of print drivers and print applications, and is configured to identify a compatible print driver and/or print application for the computing device, based on compatibility information supplied by the computing device, as described above.

At 106, the method further includes selecting the compatible print software for downloading. Where several compatible print software components are identified, step 106 may include selecting an optimal print software component for the computing device, based on the compatibility information supplied by the computing device, and based on predefined optimization criteria (e.g. software version, creation date, etc.) as described above.

At 108, the method typically includes downloading the selected print software from the printing device 12, 12′ to the computing device 14, 14′, and installing the print software on the computing device 14, 14′. At 110, the method typically includes, upon completion of the download and installation, changing the printing device from a download and installation mode to a print mode. For example, for the system embodiment shown in FIG. 2, the printing device 12′ may be configured to be recognized initially by the computing device 14′ as a file system, but after downloading an installation of print software 17′ on computing device 14′, the printing device may be configured to change from a file system mode to a print mode such that the computing device recognizes the printing device as a printer, fax machine, copier, etc. Finally, at 112, the method may include printing the documents from the computing device on the printing device.

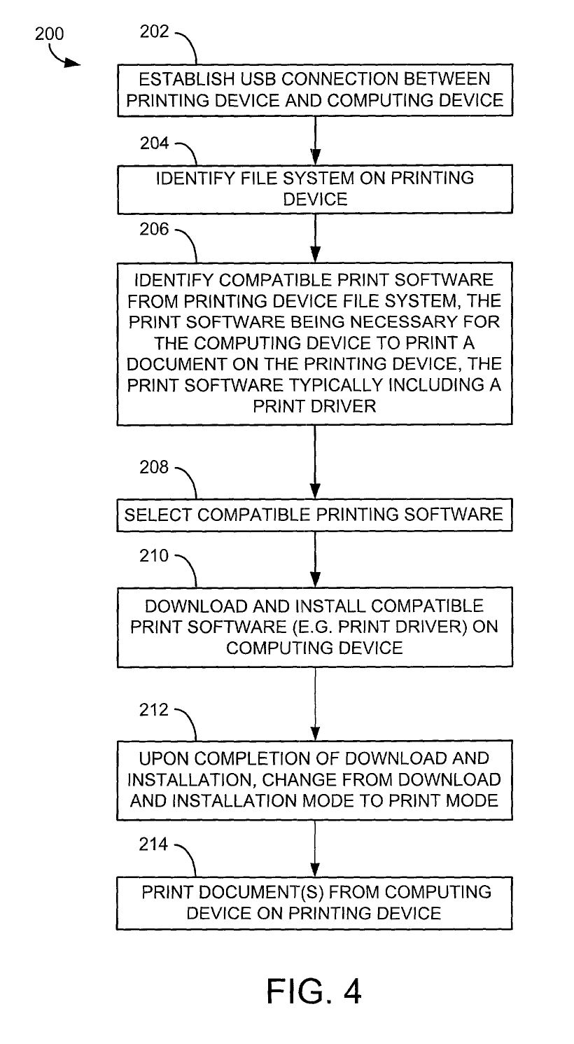

FIG. 4 shows a method 200 for use in printing a document from a computing device on a printing device, according to another embodiment of the present invention. Typically, method 200 is implemented by system 10′, shown in FIG. 2, although it will be understood that various other hardware configurations may be used to implement method 200.

At 202, method 200 typically includes establishing a USB connection between the printing device 12′ and the computing device 14′. At 204, the method typically includes the computing device 14′ identifying a file system 19′ on the printing device 12′.

At 206, the method typically includes identifying compatible print software 17′ from the printing device file system 19′. Typically, this includes identifying a compatible print driver from among a plurality of such print drivers stored on the printing device. As described above, computing device 14′ may be configured to pass compatibility information to printing device 12′, and the printing device 12′ may be configured to identify the compatible print driver using this compatibility information.

At 208, the method typically includes selecting the compatible print software for download. Where a plurality of compatible print software components exist, step 208 may include selecting optimal compatible print software, based on predetermined optimization criteria, and based on the compatibility information.

At 210, the method includes downloading and installing the selected print software on the computing device. At 212, the method includes, upon completion of the download and installation, changing the printing device from a download and installation mode to a print mode. This is typically accomplished by changing the printing device from a device that is recognized by computing device 14′ as a file system, to a device that is recognized as a printer, fax machine, copier, etc. At 214, the method may include printing the documents from computing device 14′ to printing device 12′.

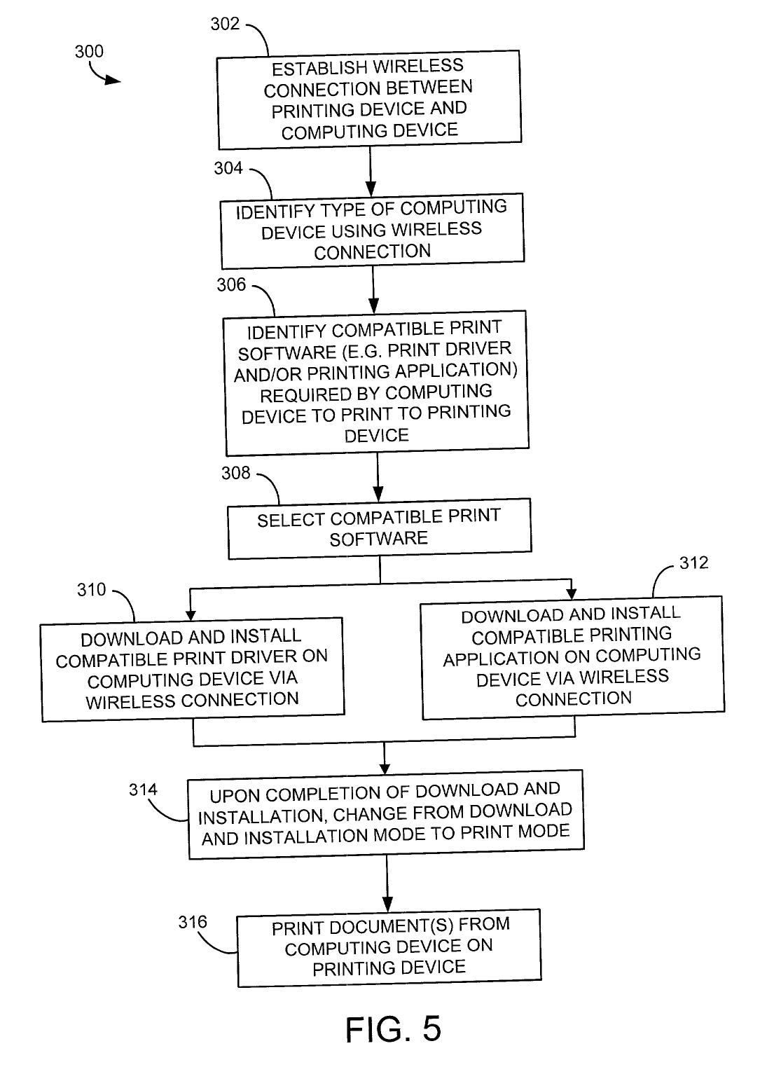

FIG. 5 shows a method 300 for use in printing a document 32 from a computing device 14 to a printing device 12, according to another embodiment of the present invention. Method 300 may be implemented by system 10 shown in FIG. 1, although alternatively various other hardware configurations may be used.

At 302, the method typically includes establishing a wireless communication link 28 between the printing device 12 and a computing device 14. At 304, the method typically includes identifying the type of computing device 14 using the wireless communication link 28. Alternatively, the method may include identifying a different form of compatibility information relating to the computing device, such as the type of operating system or browser executed on the device.

At 306, the method includes identifying compatible print software, e.g. a compatible print driver 18 and a compatible print application 20, required by computing device 14 to print documents 32 on the printing device 12. The print driver and print application software components have functions described above.

At 308, the method further includes selecting the compatible print software components for download. Where many compatible print software components are identified at 306, step 308 may include selecting optimal print software for download based on predetermined optimization criteria, and on the compatibility information.

At 310, the method includes downloading and installing the compatible print driver on the computing device, via the wireless communication link 28. At 312, the method includes downloading and installing the compatible print application on the computing device, via the wireless communication link.

At 314, the method includes, upon completion of download and installation at 310, 312, changing the printing device 12 from a download and installation mode to a print mode in which the printing device is ready to receive print jobs from the computing device. At 316, the method includes printing the documents from the computing device on the printing device.

The above described embodiments of the present invention enable a user to approach a printing device in an unfamiliar environment with a laptop, PDA, or other computing device, establish a wireless or hardware communication link with the printing device, download print software necessary to print documents from the computing device on the printing device, and print a selected document from the computing device on the printing device, thereby avoiding the above-described inconvenience and frustration of prior systems.

While the invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

We claim:

1. A system for use in enabling printing of a document, the system comprising:
a printing device configured to establish a communication link with a computing device, the printing device including memory having print software stored therein, the print software being transferable to and executable on the computing device and, upon execution, configured to enable the computing device to print documents to the printing device;
wherein the printing device is configured to download the print software to the computing device upon establishment of the communication link between the printing and computing devices.

2. The system of claim 1, wherein the print software includes a print driver.

3. The system of claim 1, wherein the print software includes a print application configured to send a print job from the computing device to the printing device.

4. The system of claim 1, wherein the communication link is a wireless communication link.

5. The system of claim 4, wherein the wireless communication link is an infrared communication link.

6. The system of claim 4, wherein the wireless communication link is a radio frequency communication link.

7. The system of claim 1, wherein the communication link is a hardware link.

8. The system of claim 7, wherein the hardware communication link is a USB communication link.

9. The system of claim 1, wherein the printing device includes a file system accessible by the computing device.

10. The system of claim 9, wherein the file system includes a start-up program configured to automatically execute and download the print software to the computing device, upon recognition of the file system by the computing device.

11. The system of claim 1, wherein the printing device is configured to identify print software that is compatible with the computing device.

12. The system of claim 11, wherein the printing device is configured to select the compatible print software for downloading to the computing device.

13. The system of claim 1, wherein the communication link is established in response to a signal from the computing device to the printing device.

14. The system of claim 1, wherein the printing device is configured to periodically broadcast a signal to the computing device for the purpose of establishing the communication link.

15. A method for use in enabling printing on a printing device, the method comprising:
detecting the establishment of a communication link between a computing device and the printing device; and
in response to the establishment of the communication link, downloading print software stored in memory of the printing device to the computing device, the print software being useful in the computing device printing documents on the printing device.

16. The method of claim 15, wherein downloading print software includes sending the print software via a wireless communication link.

17. The method of claim 15, wherein downloading print software includes sending the print software via a hardware link.

18. The method of claim 15, further comprising sending a print job from the computing device to the printing device.

19. The method of claim 18, wherein sending the print job includes sending the print job via a wireless communication link.

20. The method of claim 18, wherein sending the print job includes sending the print job via a hardware link.

21. The method of claim 15, further comprising automatically executing and downloading the print software to the computing device, upon recognition of a file system by the computing device.

22. The method of claim 15, further comprising, identifying print software that is compatible with the computing device.

23. The method of claim 22, further comprising, selecting the compatible print software on the printing device for downloading to the computing device.

24. The method of claim 15, further comprising selecting print software from a plurality of software components stored in memory of the printing device.

25. The method of claim 15, further comprising signaling the printing device and establishing the communication link in response to signaling the printing device.

26. The method of claim 15, further comprising periodically broadcasting a signal from the printing device for the purpose of establishing the communication link.

27. A program storage medium readable by a computing device, the program storage medium tangibly embodying a program of instructions executable by the computing device to perform a method for use in enabling a computing device to print on a printing device, the method comprising:
detecting establishment of a communication link between the computing device and the printing device; and
in response to the establishment of the communication link, downloading print software stored in the memory of the printing device to the computing device, the print software being useful in the computing device to print documents on the printing device.

28. A printing device comprising:
memory having a print driver configured to enable printing on the printing device;
and
a communication link selectively established between the printing device and a computing device to enable download of the print driver from the printing device to the computing device in response to receipt of a signal.

29. A printing method comprising:
receiving a signal to establish a communication link between a printing device and a computing device;
establishing the communication link with the computing device;
upon establishing the communication link, downloading a printer driver stored in memory of the printing device to the computing device via the communication link, the printer driver being useful in the computing device printing on the printing device;
receiving a print job from the computing device;
and
printing the print job on the printing device.

30. A printing device, comprising:
a file system;
print software stored in the file system; and
means for communicatively coupling the printing device to a computing device so as to allow the computing device to selectively download from the printing device portions of the print software.

31. The printing device of claim 30, wherein the print software further includes a start-up program usable for initiating downloading from the printing device of the portions of the print software.

32. The printing device of claim 30, wherein the portions of the print software correspond to characteristics of the computing device.

33. The printing device of claim 30, wherein the characteristics of the computing device are selected from a group consisting of an operating system identifier, an application program identifier, and a computing device identifier.

34. A processor-readable medium for a printing device having processor-executable instructions thereon which, when executed by a processor, cause the processor to:
detect establishment of a communications link between the printing device and a computing device; and
in response to the establishment of a communications link, uploading print software stored in memory of the printing device to the computing device, the print software being useful in the computing device for printing on the printing device.
